(19) United States
(12) Patent Application Publication
(10) Pub. No.: US 2026/0089492 A1
(43) Pub. Date: Mar. 26, 2026

(54) ENHANCED DATA PRIVACY GROUP MOVE FOR STATIONS

(71) Applicant: Cisco Technology, Inc., San Jose, CA (US)

(72) Inventors: Domenico FICARA, Essertines-Sur-Yverdon (CH); Juan Carlos ZUNIGA, Montreal (CA); Jerome HENRY, Pittsboro, NC (US); Ugo M. CAMPIGLIO, Morges (CH); Javier I. CONTRERAS ALBESA, Sant Cugat del Valles (ES)

(21) Appl. No.: 19/207,143

(22) Filed: May 13, 2025

Related U.S. Application Data
(60) Provisional application No. 63/697,140, filed on Sep. 20, 2024.

(51) Int. Cl. H04W 12/02; H04L 61/50; H04L 101/622; H04W 76/10

(52) U.S. Cl. CPC H04W 12/02; H04L 61/50; H04W 76/10; H04L 2101/622

(57) ABSTRACT

Techniques and apparatus for enhanced data privacy (EDP) operations for stations (STAs) are described. An example technique includes establishing a wireless communications link between an access point (AP) and STA. Establishing the wireless communications link includes assigning the STA to a first EDP group associated with first timing information for rotating wireless frame anonymization parameters at epoch transitions. A frame is transmitted to the STA indicating the first EDP group. The wireless communications link is maintained with the STA based on the first timing information. An EDP request frame is transmitted to the STA and indicates a request for the STA to join a second EDP group different from the first EDP group and one or more epoch parameters for the second EDP group. The wireless communications link is maintained with the STA based on second timing information for rotating wireless frame anonymization parameters for the second EDP group.

### CROSS-REFERENCE TO RELATED APPLICATIONS

This application claims benefit of co-pending U.S. Provisional Patent Application Ser. No. 63/697,140 filed Sep. 20, 2024. The aforementioned related patent application is herein incorporated by reference in its entirety.

### TECHNICAL FIELD

Embodiments presented in this disclosure generally relate to wireless communications. More specifically, embodiments disclosed herein relate to enhanced data privacy (EDP) operations for stations (STAs).

### BACKGROUND

In many wireless networks, clients (e.g., wireless devices or non-access point (AP) stations (STAs) (non-AP STAs)) can be susceptible to tracking by unauthorized (e.g., malicious) users. For example, an unauthorized user can gain access to a wireless network with a rogue AP and use the rogue AP to intercept packages and track the movement and activity of clients within the network based on the intercepted packets. To mitigate against such unauthorized tracking, certain wireless networks (e.g., Institute of Electrical and Electronics Engineers (IEEE) 802.11, also known as WiFi) have introduced several privacy enhancements that aim to provide clients with the ability to avoid being tracked within a network. These privacy enhancements generally involve anonymizing frame parameters, such as an association identifier (AID), a medium access control (MAC) address, a packet number (PN), a sequence number (SN), among others.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 illustrates an example system, according to certain embodiments.

FIG. 2 illustrates an example enhanced data privacy (EDP) epoch timeline.

FIG. 3 illustrates a call flow for suggesting an EDP group move, according to certain embodiments.

FIG. 4 illustrates another call flow for suggesting an EDP group move, according to certain embodiments.

FIG. 5 is a flowchart of a method for wireless communications, according to certain embodiments.

FIG. 6 illustrates an example computing device, according to certain embodiments.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment described herein is a method for wireless communication performed by an access point (AP). The method includes establishing a wireless communications link between the AP and a wireless station. Establishing the wireless communications link includes assigning the wireless station to a first enhanced data privacy (EDP) group associated with first timing information for rotating wireless frame anonymization parameters at epoch transitions. The method also includes transmitting a wireless frame to the wireless station indicating the first EDP group. The method also includes maintaining the wireless communications link with the wireless station based at least in part on the first timing information for rotating wireless frame anonymization parameters for the first EDP group. The method further includes transmitting an EDP request frame to the wireless station. The EDP request frame indicates (i) a request for the wireless station to join a second EDP group different from the first EDP group and (ii) one or more epoch parameters for the second EDP group. The method further includes maintaining the wireless communications link with the wireless station based at least in part on second timing information for rotating wireless frame anonymization parameters for the second EDP group.

Another embodiment described herein is an access point (AP). The AP includes one or more memories collectively storing instructions and includes one or more processors communicatively coupled to the one or more memories. The one or more processors are individually or collectively configured to execute the instructions to cause the AP to perform an operation. The operation includes establishing a wireless communications link between the AP and a wireless station. Establishing the wireless communications link includes assigning the wireless station to a first enhanced data privacy (EDP) group associated with first timing information for rotating wireless frame anonymization parameters at epoch transitions. The operation also includes transmitting a wireless frame to the wireless station indicating the first EDP group. The operation further includes maintaining the wireless communications link with the wireless station based at least in part on the first timing information for rotating wireless frame anonymization parameters for the first EDP group. The operation further includes transmitting an EDP request frame to the wireless station. The EDP request frame indicates (i) a request for the wireless station to join a second EDP group different from the first EDP group and (ii) one or more epoch parameters for the second EDP group. The operation further includes maintaining the wireless communications link with the wireless station based at least in part on second timing information for rotating wireless frame anonymization parameters for the second EDP group.

Another embodiment described herein is a non-transitory computer-readable medium. The non-transitory computer-readable includes computer-executable code, which when executed by one or more processors of an access point perform an operation. The operation includes establishing a wireless communications link between the AP and a wireless station. Establishing the wireless communications link includes assigning the wireless station to a first enhanced data privacy (EDP) group associated with first timing information for rotating wireless frame anonymization parameters at epoch transitions. The operation also includes transmitting a wireless frame to the wireless station indicating the first EDP group. The operation further includes maintaining the wireless communications link with the wireless station based at least in part on the first timing information for rotating wireless frame anonymization parameters for the first EDP group. The operation further includes transmitting an EDP request frame to the wireless station. The EDP request frame indicates (i) a request for the wireless station to join a second EDP group different from the first EDP group and (ii) one or more epoch parameters for the second EDP group. The operation further includes maintaining the wireless communications link with the wireless station based at least in part on second timing information for rotating wireless frame anonymization parameters for the second EDP group.

### EXAMPLE EMBODIMENTS

Certain wireless systems (e.g., IEEE 802.11bi among other wireless standards) support enhanced data privacy (EDP), which includes several privacy enhancements that aim to provide clients with the ability to avoid being tracked within a network. EDP involves dynamically updating various (unencrypted) wireless frame parameters associated with a client (e.g., AID, MAC address, SN, PN, among other parameters) at defined time intervals, referred to herein as “epochs” or “EDP epochs.” Such periodic changes in wireless frame parameters may be referred to as frame anonymization.

Frame anonymization enables restricting presence monitoring time windows to portions of a single association between a client and AP. As such, frame anonymization may improve privacy by making it difficult for an observer (e.g., attacker, malicious user, unauthorized user) to correlate the (updated) frame parameters with a client's presence across different time intervals.

As noted, common frame parameters that can be tracked include the MAC address, AID, SNs in frame headers, and other protocol-specific identifiers that are used across multiple transmissions. A client assigned to (or otherwise associated with) a given EDP group may update (e.g., rotate) one or more of such wireless frame parameters at each epoch according to EDP parameters associated with the EDP group. Such EDP parameters may include a duration of the epoch, start time of the epoch, among other parameters.

Each epoch may start with a transition period. During the transition period of an epoch, the wireless frame parameters assigned to the client during a preceding epoch (if any) may be valid for certain operations, such as retransmission of a frame, reception of a retransmitted frame, and frame acknowledgment. That is, the transition period during a current epoch may allow for stored/buffered frames from a previous epoch and/or frames subject to retransmission from a previous epoch an opportunity to be transmitted using wireless frame parameters assigned to the client for the previous epoch.

By way of example, assume an AID is a wireless frame parameter that can be updated (e.g., rotated) at each epoch. In this example, during the transition period between an epoch K and an epoch K+1 (e.g., the time period where the old AID is still accepted but new transmissions use the new AID), an AP generally has to be able to receive frames that have been enqueued in epoch K with previous AID marking. For instance, triggered multi-packet exchanges may start in epoch K and finish in epoch K+1.

However, because of this constraint, effectively half of the total set of AIDs can be used in any epoch, for each EDP group. For example, if there is a single EDP group and M available AIDs, then N1=M/2 AIDs may be available to the AP for assigning to clients in the EDP group during the transition period between epochs. At the beginning of epoch K, N1 AIDs may be assigned, and at the beginning of epoch K+1, these N1 AIDs cannot be immediately reused, effectively blocking these N1 AIDs from use, and limiting the AP to the next N2=M/2 AIDs. Thus, although a maximum of M AIDs (and thus M clients) may be supported within the basic service set (BSS), the BSS may be effectively limited to half that capacity during the transition period. Moreover, if the potential support of legacy STAs by the same AP/BSS is considered, then the number of available AIDs may be halved again, limiting the ability of the AP to scale wireless access support. By way of example, assuming there are 2000 total AIDs and 1000 legacy clients that use a static AID, the AP may be left with 1000 total AIDs for EDP operation, limiting the number of AIDs to 500 during transition periods.

On the other hand, since certain wireless systems (e.g., IEEE 802.11bi) support multiple EDP groups, it may be desirable to have clients distributed across multiple groups, e.g., to improve privacy protection of the clients. However, while such systems may allow an AP to reject a client's request to join a given EDP group, the AP in these systems generally does not have the capability to suggest the client move to a different EDP group.

For example, when a client joins a BSS, the AP may provide a list of current EDP groups to the client along with a respective set of EDP parameters (e.g., approximate number of clients in the EDP group, minimum epoch duration, minimum number of AID values to join the EDP group, among other information) for each EDP group. The client may send a request to join one of the EDP groups (e.g., a first EDP group from the list of current EDP groups), based on various criteria. Such criteria may include a desired level of privacy, which may be based on the number of clients in the EDP group, duration of epochs for the EDP group, etc. Upon receiving the request, the AP may accept or reject the client's request to join the EDP group.

However, one issue with this approach for assigning clients to EDP groups is that the approach does not provide APs with the flexibility to manage (e.g., reorganize) EDP groups. For example, a client may prefer to join a large EDP because the crowd that the client will be part of is larger (e.g., allowing the client to hide within the larger crowd for better protection from unauthorized tracking). However, a large EDP group may cost the AP in terms of AIDs (and other wireless frame parameters), limiting the number of clients in the EDP group because of each transitory period.

Certain embodiments described herein provide techniques and apparatus for improving EDP operation during transition periods between EDP epochs. As described in greater detail herein, in certain embodiments, an AP using the techniques described herein may (re)assign a client to different EDP groups over time, e.g., during EDP operation. For example, the AP may (re)assign the client to a first EDP group for a first one or more epochs and (re)assign the client to a second EDP group, different from the first EDP group, for a second one or more epochs. In this manner, the AP can reorganize the EDP groups in use (e.g., by redistributing which clients are included in the EDP groups) to ensure that a certain number of wireless frame parameters are available to the clients for frame anonymization, thus maintaining a target level of privacy for clients. In turn, by maintaining a target level of privacy for clients, certain embodiments described herein can significantly improve the communication performance of clients during EDP operation in terms of increased throughput, decreased latency, and higher transmission range, as illustrative examples.

Note, the techniques described herein for suggesting EDP group moves for clients may be incorporated into (such as implemented within or performed by) a variety of wired or wireless apparatuses (such as nodes). In some implementations, a node includes a wireless node. Such wireless nodes may provide, for example, connectivity to or from a network (such as a wide area network (WAN) such as the Internet or a cellular network) via a wired or wireless communication link. In some implementations, a wireless node may include an AP, a controller, or client.

Although the terms “first,” “second,” “third,” etc., may be used herein to describe various elements, components, regions, layers and/or sections, these elements, components, regions, layers and/or sections should not be limited by these terms. These terms may be only used to distinguish one element, component, region, layer or section from another element, component, region, layer, or section. Terms such as “first,” “second,” and other numerical terms, when used herein, do not imply a sequence or order unless clearly indicated by the context. Thus, a first element, component, region, layer, or section discussed herein could be termed a second element, component, region, layer, or section without departing from the teachings of the example embodiments.

As used herein, a hyphenated form of a reference numeral refers to a specific instance of an element and the un-hyphenated form of the reference numeral refers to the collective element. Thus, for example, device “12-1” refers to an instance of a device class, which may be referred to collectively as devices “12” and any one of which may be referred to generically as a device “12”.

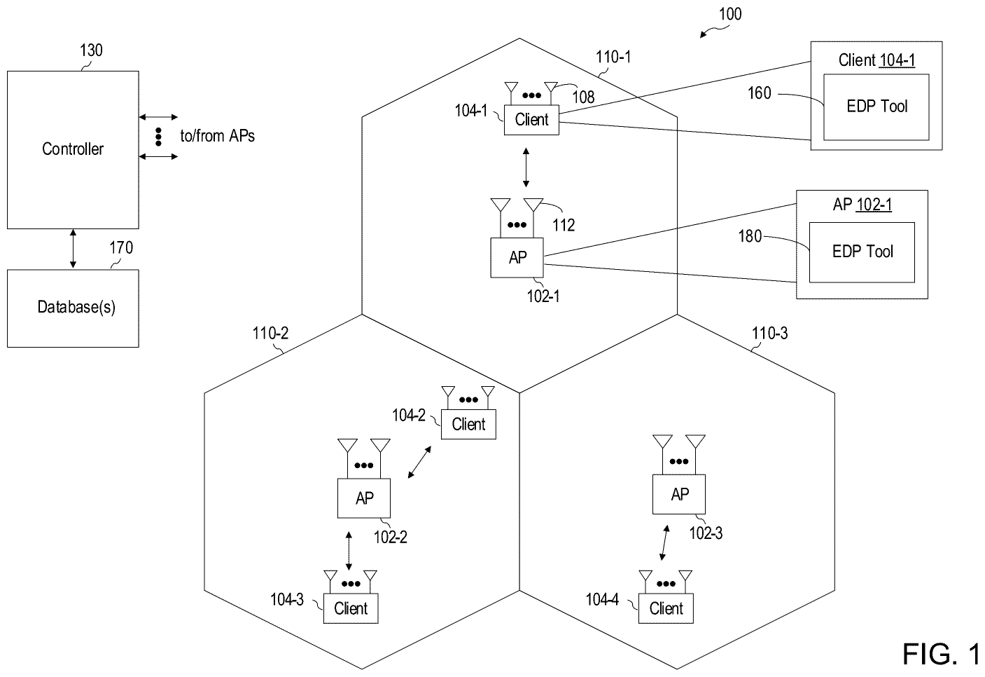

FIG. 1 illustrates an example system 100 in which one or more techniques described herein can be implemented, according to certain embodiments. As shown, the system 100 includes, without limitation, one or more APs (e.g., AP 102-1, AP 102-2, and AP 102-3), one or more clients (e.g., client 104-1, client 104-2, client 104-3, and client 104-4), a controller 130, and one or more databases 170. In certain embodiments, the system 100 may implement a wireless network according to one or more wireless communication standards, such as one or more of the IEEE 802.11 standards.

An AP is generally a fixed station that communicates with client(s) and may be referred to as a base station, a wireless device, a network device, an AP multi-link device (MLD), an AP station (STA), or some other terminology. A client may be fixed or mobile and also may be referred to as a mobile STA, a client STA, a STA, a wireless device, a non-AP multi-link device (MLD), a non-AP STA, or some other terminology. Note that while a certain number of APs and clients are depicted, the system 100 may include any number of APs and clients.

As used herein, an AP along with the clients associated with the AP (e.g., within the coverage area (or cell) of the AP) may be referred to as a basic service set (BSS). Here, AP 102-1 is the serving AP for client 104-1, AP 102-2 is the serving AP for clients 104-2 and 104-3, and AP 102-3 is the serving AP for client 104-4. The AP 102-1, AP 102-2, and AP 102-3 are neighboring (peer) APs. The APs 102 may communicate with one or more clients 104 on the downlink and uplink. The downlink (e.g., forward links) is the communication link(s) from the AP(s) 102 to the client(s) 104, and the uplink (e.g., reverse links) is the communication link(s) from the client(s) 104 to the AP(s) 102. In some cases, a client may also communicate peer-to-peer with another client.

As shown in FIG. 1, each client 104 includes one or more radios 108. The client 104 can use one or more of the radios 108 to form links with an AP 102. As also shown, each AP 102 includes one or more radios 112 that the AP 102 can use to form links with one or more clients 104 and/or one or more APs 102. In general, the AP(s) 102 and the client(s) 104 may form any suitable number of links for communication using any suitable frequencies and using any suitable communication protocols. In some instances, a client 104 may form multiple links with a single AP 102.

In certain embodiments, the APs 102 may be controlled or managed at least partially by the controller 130. Here, the controller 130 couples to and provides coordination and control for the APs 102 1-3. For example, the controller 130 may handle adjustments to RF power, channels, authentication, and security for the APs. The controller 130 may also coordinate the links formed by the client(s) 104 with the APs 102. The controller 130 and APs 102 may utilize a same control plane protocol.

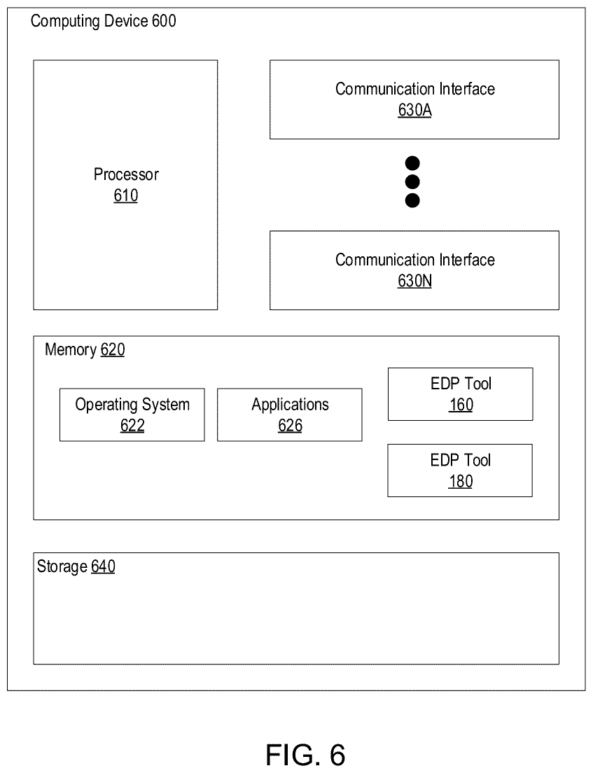

The operations of the controller 130 may be implemented by any device or system, and may be combined or distributed across any number of systems. For example, the controller 130 may be a wireless local area network (WLAN) controller for the deployment of APs 102 within the system 100. In some examples, the controller 130 is included within or integrated with an AP 102 and coordinates the links formed by that AP 102 (or otherwise provides control for that AP). For example, each AP 102 may include a controller that provides control for that AP. In some examples, the controller 130 is separate from the APs 102 and provides control for those APs. In FIG. 1, for example, the controller 130 may communicate with the APs 102 1-3 via a (wired or wireless) backhaul. The APs 102 1-3 may also communicate with one another, e.g., directly or indirectly via a wireless or wireline backhaul. The database(s) 170 is representative of a storage system(s) that may include, without limitation, radio resource configurations and radio resource management (RRM) information, among other information. Example hardware that may be included in an AP 102 and client 104 is discussed in greater detail with respect to FIG. 6.

In certain embodiments, one or more of the clients 104 and APs 102 may support EDP, which includes several privacy enhancements that aim to provide clients 104 with the ability to avoid being tracked within a network. As part of EDP, the AP(s) 102 and/or clients may dynamically update various (unencrypted) wireless frame parameters at defined time intervals (also referred to herein as epochs). For example, a client 104 assigned to (or otherwise associated with) a given EDP group may update one or more wireless frame parameters at each epoch according to EDP parameters associated with the EDP group.

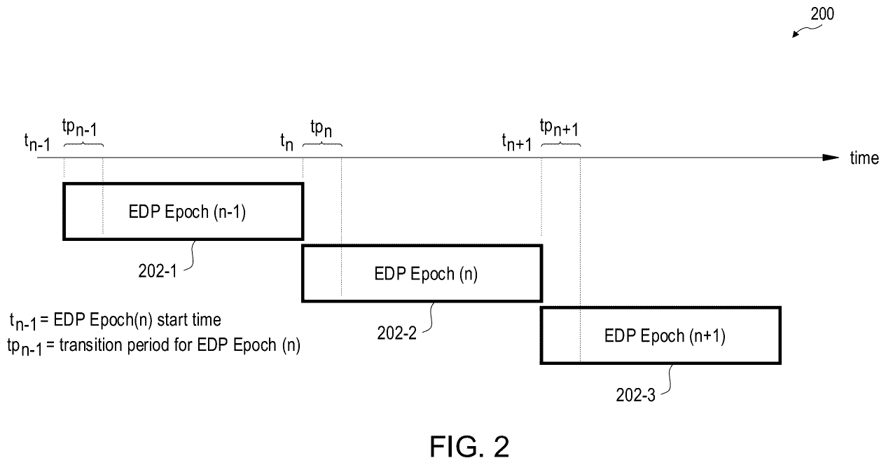

FIG. 2 illustrates an example EDP epoch timeline 200 including one or more epochs 202. As shown, each epoch 202 starts with a transition period (tp). For example, epoch 202-1 (EDP epoch (n−1)) starts with tpₙ₋₁, epoch 202-2 (EDP epoch (n)) starts with tpₙ, and epoch 202-3 (EDP epoch (n+1)) starts with tpₙ₊₁. During the transition period of an epoch, the wireless frame parameters assigned to the client during a preceding epoch (if any) may be valid for certain operations, such as retransmission of a frame, reception of a retransmitted frame, and frame acknowledgment. A transition period may terminate at the end of a transition timeout interval or before the end of the transition timeout interval, after the completion of the successful transmissions or retransmissions initiated during the preceding epoch (if any), whichever comes first.

However, one issue with the epoch timeline 200 illustrated in FIG. 2 is that the epoch configuration can impact the level of privacy that can be achieved within an EDP group. For example, because an AP generally has to be able to receive frames during the transition period of an epoch that use wireless frame parameters associated with a previous epoch, the amount of wireless frame parameters (e.g., AIDs) available to a set of clients within an EDP group may be limited. In the case of AIDs, for instance, the total set of AIDs that can be used in any epoch for each EDP group may be halved due in part to the epoch configuration.

To address this, certain embodiments provide techniques that allow the APs 102 to move clients 104 to different EDP groups over time. By allowing an AP to move a client 104 to a particular EDP group, the AP can efficiently reorganize the EDP groups to ensure that a certain number of wireless frame parameters are available to the clients for frame anonymization. Referring back to FIG. 1, the AP 102 includes an EDP tool 180, which is configured to perform one or more techniques described herein and is described in greater detail below. The EDP tool 180 may be implemented with hardware, software, or combinations thereof. As also shown, the client 104 includes an EDP tool 160, which is configured to perform one or more techniques described herein and is described in greater detail below. The EDP tool 160 may be implemented with hardware, software, or combinations thereof.

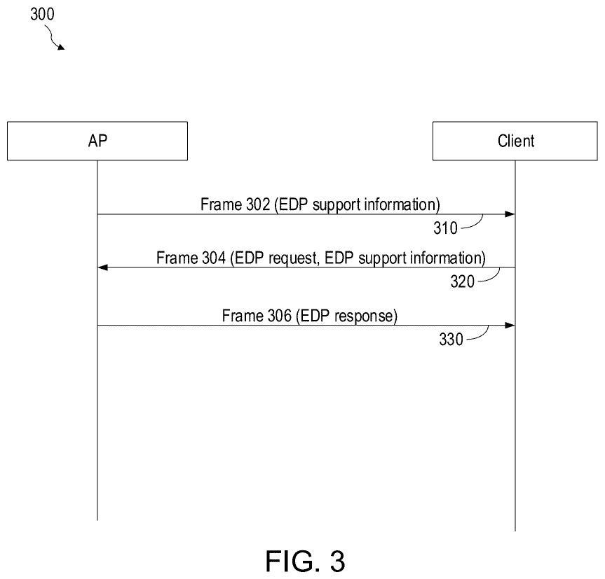

FIG. 3 illustrates an example call flow 300 for suggesting EDP group moves to a client, according to certain embodiments. Here, the call flow 300 depicts example operations by an AP (e.g., AP 102) and a client (e.g., client 104).

At step 310, the AP transmits a frame 302 to the client. The frame 302 may include EDP support information for the AP. Such EDP support information may include an indication of whether the AP supports EDP operation, a list of current EDP groups (assuming the AP supports EDP operation), and a respective set of EDP parameters for each EDP group (assuming the AP supports EDP operation). The indication of whether the AP supports EDP operation may include an indication of whether the AP supports frame anonymization including a randomized media access control (MAC) address rotation management protocol, as an illustrative example. The frame 302 may be a management frame (e.g., a beacon frame, a probe response frame, etc.) or an action frame (e.g., (re)association response frame).

Each set of EDP parameters for a given EDP group within the frame 302 may include various information, such as an EDP group identifier (ID) for the EDP group, an epoch interval for the EDP group, a start time of an initial epoch for the EDP group, an estimated number of epochs remaining for the EDP group, an approximate number of clients in the EDP group, and an AID storage size for the EDP group, as illustrative examples. The epoch interval may include the length of the epoch for the EDP group. In some cases, the length of the epoch may be indicated with an approximate maximum epoch duration for the EDP group. The estimated number of epochs remaining for the EDP group indicates the number of epochs remaining after the current epoch finishes. The approximate number of clients may include an indication of the number of clients participating in the EDP group and/or an indication of a percentage of associated clients participating in the EDP group. The AID storage size for the EDP group may indicate the minimum number of AID values that a client should have to be allowed to join in the EDP group.

At step 320, the client transmits a frame 304 to the AP. The frame 304 may include an EDP request and EDP support information for the client. The EDP support information may include an indication of whether the client supports EDP operation and, if the client does support EDP operation, an AID storage size for the client, one or more minimum epoch pacing parameters for the client, and rotation pace preference information for the client. The AID storage size may indicate the number of AID values that the client can store. The minimum epoch pacing parameter(s) may indicate the minimum epoch duration value that the client can support. The rotation pace preference information may indicate a preferred rotation pace for rotating wireless frame anonymization parameters.

Although the EDP request and EDP support information are depicted as separate information elements within the frame 304 for the sake of clarity, in certain embodiments, the EDP support information may be included as part of the EDP request. For example, as described in greater detail herein, the EDP request may include an EDP element (e.g., information element) that includes the EDP support information. In some cases, the EDP request may be referred to herein as an “EDP request frame.” The frame 304 may be an action frame, such as a (re)association request frame, as an illustrative example.

In certain embodiments, the EDP request includes a request to join a particular EDP group. For example, the client may request to join one of the EDP groups indicated in the frame 302. In some such embodiments, the EDP request may include an EDP element (e.g., information element) including the EDP parameters for the EDP group the client requests to join along with the EDP support information for the client. Such EDP parameters may include the EDP group ID, the epoch duration for the EDP group, or a combination thereof.

In certain embodiments, the EDP request includes a request to create a particular EDP group. In some such embodiments, the EDP request may indicate a set of EDP parameters for the EDP group to be created along with the EDP support information for the client.

At step 330, the AP transmits a frame 306 to the client. In certain embodiments, the frame 306 is transmitted in response to the frame 304. In some such embodiments, the frame 306 includes an EDP response indicating whether the EDP request (in frame 304) is accepted or rejected. In some cases, the EDP response may be referred to herein as an “EDP response frame.” The frame 306 may be an action frame, such as a (re)association response frame.

In certain embodiments, the AP may assign the client to an existing EDP group with the requested set of EDP parameters. For example, the AP may select one of the existing EDP groups that has the requested epoch interval length, and assign the client to the selected EDP group. In such embodiments, the EDP response may include (i) a status field set to “SUCCESS” to indicate that the result of the EDP request was successful and (ii) an EDP element including EDP parameters of the assigned EDP group.

In certain embodiments, the AP may not be able to find an existing EDP group with the exact requested set of EDP parameters. In such embodiments, the AP may assign the client to an (existing) EDP group with a set of EDP parameters similar to the requested set of EDP parameters. For example, the AP may select the EDP group to assign the client to, based on the minimum epoch pacing parameter(s) for the client, the rotation pace preference information for the client, or any combination thereof.

In some cases, the AP may select the EDP group that has an epoch interval that is greater than the epoch interval indicated in the minimum epoch pacing parameter(s) for the client. Additionally or alternatively, in some cases, the AP may select the EDP group whose epoch duration is less than or equal to the epoch duration requested within the EDP request. In such cases, the AP may perform a best match between the rotation preference information for the client and the epoch durations corresponding to the EDP groups.

When the AP assigns the client to an EDP group having similar EDP parameters to the requested EDP parameters, the EDP response may include (i) a status field set to a value indicating that the client has been assigned to another EDP group with similar EDP parameters as the requested EDP parameters and (ii) an EDP element including EDP parameters of the assigned EDP group. In some cases, the value may be “SUCCESS SIMILAR EPOCH.”

In certain cases, if the frame 304 does not include EDP support information for the client (e.g., the frame 304 lacks an indication of minimum epoch pacing parameter(s) and/or rotation pace preference information), then the AP may assign (via the frame 306) the client to a default EDP group (e.g., predetermined EDP group with a predetermined set of EDP parameters).

In certain embodiments, after assigning the client to a given EDP group, the AP may determine to move the client to a different EDP group. The determination to move the client to a different EDP group may be an asynchronous operation that is performed when the AP determines a set of conditions is satisfied. In some cases, the set of conditions may be based on a number of available AIDs. For example, the AP may determine that a number of available AIDs is less than a threshold. In some cases, the set of conditions may be based on occurrence of a predetermined time interval. For example, the AP may periodically move a set of clients to different EDP groups. In some cases, the set of conditions may be based on receiving a request from the client to join a different EDP group.

In some cases, the set of conditions may be based on a respective size of one or more EDP groups. Such conditions may include, for example, the size of the current EDP group in which the client is assigned is greater than a respective first threshold for the EDP group, the size of the current EDP group in which the client is associated is less than a respective second threshold for the EDP group, the size of another EDP group is greater than the respective first threshold, or the size of another EDP group is less than the respective second threshold. Note, that the first and second thresholds for each EDP group may be global thresholds (e.g., the same for each group) or may be particular to the EDP group.

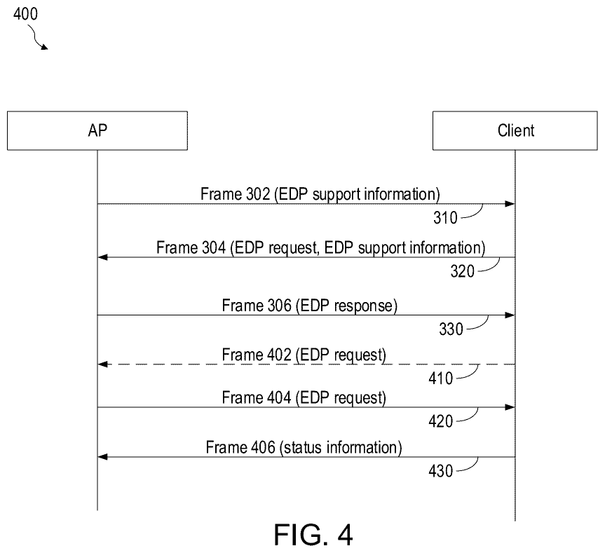

FIG. 4 illustrates an example call flow 400 for suggesting EDP group moves to a client, according to certain embodiments. Here, the call flow 400 depicts example operations by an AP (e.g., AP 102) and a client (e.g., client 104). Note certain operations depicted in call flow 400 may be similar to operations depicted in call flow 300. For example, steps 310, 320, and 330 depicted in call flow 300 may be similar to steps 310, 320, and 330 depicted in call flow 400.

Compared to call flow 300, in call flow 400, the AP transmits a frame 404 to the client to move the client to a different EDP group. As noted, the AP may determine to move the client to a different EDP group when certain conditions are satisfied. As noted, such conditions may include receiving a request from the client to join another EDP group (e.g., frame 402 may include an EDP request to join a different EDP group), determining occurrence of a predefined time interval, determining that a respective size of one or more EDP groups satisfies a respective one or more thresholds for the one or more EDP groups, etc.

As part of moving the client to a different EDP group, the frame 404 may include an EDP request indicating a request for the client to join a different EDP group. The EDP request may also include an EDP element that includes the EDP parameters for the EDP group that the AP is requesting the client to join. In some cases, the new EDP group may include similar EDP parameters as the previous EDP group that the client was a part of, but with a different epoch boundary time (e.g., to limit the number of clients changing AIDs at the same time). For example, the new EDP group may have an epoch interval that is greater than the epoch interval indicated in the minimum epoch pacing parameter(s) for the client. Additionally or alternatively, in some cases, the new EDP group may have an epoch duration is less than or equal to the epoch duration for the previous EDP group.

In certain embodiments, the AP may send the frame 404 to multiple clients. For example, the frame 404 may be multicast and address all the clients in the current EDP group or a subset of clients within the current EDP group. Sending the frame 404 to multiple clients may allow the AP to efficiently disband or reconfigure the EDP group. In cases where the AP has to apply new configurations to the entire EDP group, the AP may move all the clients within the EDP group to another EDP group.

Alternatively, in certain embodiments, the AP may use the frame 404 to apply different EDP parameters to the current EDP group. In some such embodiments, the frame 404 may not include an EDP request to join a different group, but may include an EDP element including the updated set of EDP parameters for the current EDP group. In this manner, the AP can update EDP parameters for the current EDP group and inform the clients within the EDP group about the updated EDP parameters. In some cases, the AP may include a message within the frame 404 requesting the clients to apply the updated EDP parameters. Upon receiving the updated EDP parameters, the clients within the EDP group may decide to stay or move to another EDP group.

In certain embodiments, the frame 404 may include a suggestion (or indication) of a neighbor AP's EDP group. For example, the AP may provide a suggestion for the client(s) to move to another EDP associated with a neighboring AP. In some such embodiments, the AP may send the frame 404 as part of a neighbor report (e.g., neighbor report defined in 802.11k), as part of a BSS transition management (BTM) frame (e.g., BTM frame defined in 802.11v), or as part of an EDP request.

At step 430, the client transmits a frame 406 to the AP that includes status information associated with the EDP request in frame 404. For example, the status information may include an indication of a status of a transition to the new EDP group.

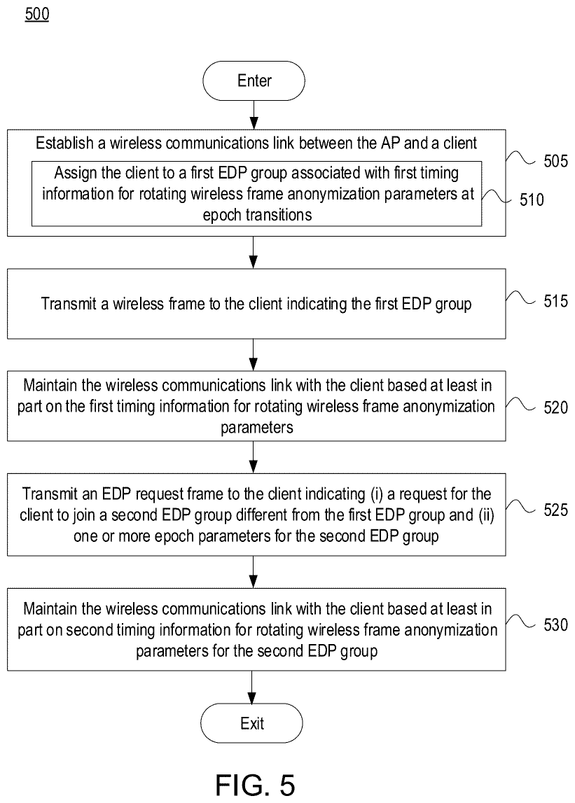

FIG. 5 is a flowchart of a method 500 for wireless communication, according to certain embodiments. The method 500 may be performed by a wireless device, such as an AP 102. For example, the EDP tool 180 may perform one or more of the blocks depicted in method 500. In certain embodiments, the method 500 is performed to move clients to different EDP groups.

Method 500 enters at block 505, where the wireless device establishes a wireless communications link between the AP and a client (e.g., client 104). Block 505 may include sub-block 510, where the wireless device assigns the client to a first EDP group associated with first timing information for rotating wireless frame anonymization parameters at epoch transitions.

At block 515, the wireless device transmits a wireless frame (e.g., frame 306) to the client indicating the first EDP group.

At block 520, the wireless device maintains the wireless communications link with the client based at least in part on the first timing information for rotating wireless frame anonymization parameters for the first EDP group.

At block 525, the wireless device transmits an EDP request frame (e.g., frame 404) to the client. The EDP request frame may indicates (i) a request for the wireless station to join a second EDP group different from the first EDP group and (ii) one or more epoch parameters for the second EDP group.

At block 530, the wireless device maintains the wireless communications link with the client based at least in part on second timing information for rotating wireless frame anonymization parameters for the second EDP group.

In certain embodiments, the method 500 further includes providing a communication (e.g., frame 302) indicating that the AP supports a randomized media access control (MAC) address rotation management protocol.

In certain embodiments, the method 500 further includes receiving a response (e.g., frame 406) from the client indicating a status of a transition to the second EDP group.

In certain embodiments, the method 500 further includes selecting the second EDP group based in part on one or more minimum epoch pacing parameters received from the client (e.g., in frame 304).

In certain embodiments, the method 500 further includes receiving, from the client, rotation pace preference information (e.g., in frame 304). The rotation pace preference information may indicate a preferred rotation pace for rotating wireless frame anonymization parameters. In some such embodiments, the first EDP group may be assigned based at least in part on the rotation pace preference information. Additionally, in some such embodiments, the first EDP group may be selected from multiple EDP groups based on a best match between the rotation pace preference information and timing information for rotating wireless frame anonymization parameters corresponding to the EDP groups.

In certain embodiments, establishing the wireless communications link includes receiving an association request frame from the client. The association request frame may indicate support for EDP groups. In certain embodiments, the first EDP group is a default EDP group if the association request frame lacks an indication of preferred pacing parameters. In certain embodiments, the wireless frame indicating the first EDP group is an association response frame.

In certain embodiments, the association request frame includes an EDP element, which includes a minimum epoch pacing parameter.

In certain embodiments, the EDP request frame is multicast to multiple clients in a basic service set (BSS).

FIG. 6 illustrates an example computing device 600, according to one embodiment. The computing device 600 can be configured to perform one or more techniques described herein. For example, the computing device 600 can perform certain operations depicted in call flow 300, call flow 400, method 500 and any other techniques (or combination of techniques) described herein. The computing device 600 may be a network entity (e.g., an AP, such as AP 102) or a wireless device (e.g., a client, such as client 104). The computing device 600 includes, without limitation, a processor 610, a memory 620, and one or more communication interfaces 630a-n (generally, communication interface 630). In one example, the communication interface 630 includes a radio.

The processor 610 may be any processing element capable of performing the functions described herein. The processor 610 represents a single processor, multiple processors, a processor with multiple cores, and combinations thereof. The communication interfaces 630 (e.g., radios) facilitate communications between the computing device 600 and other devices. The communications interfaces 630 are representative of wireless communications antennas and various wired communication ports.

The memory 620 may be either volatile or non-volatile memory and may include RAM, flash, cache, disk drives, and other computer readable memory storage devices. Although shown as a single entity, the memory 620 may be divided into different memory storage elements such as RAM and one or more hard disk drives. As shown, the memory 620 includes various instructions that are executable by the processor 610 to provide an operating system 622 to manage various functions of the computing device 600. The memory 620 also includes EDP tool 160, EDP tool 180, and one or more application(s) 626.

The computing device 600 may include storage (not shown). In some cases, the storage may be a disk drive or flash storage device. In some cases, the storage may be a combination of fixed and/or removable storage devices, such as fixed disc drives, solid state drives, removable memory cards, optical storage, network attached storage (NAS), or a storage area-network (SAN).

### EXAMPLE CLAUSES

Implementation examples are described in the following numbered clauses:
Clause 1: A method for wireless communication performed by an access point (AP), comprising: establishing a wireless communications link between the AP and a wireless station, comprising assigning the wireless station to a first enhanced data privacy (EDP) group associated with first timing information for rotating wireless frame anonymization parameters at epoch transitions; transmitting a wireless frame to the wireless station indicating the first EDP group; maintaining the wireless communications link with the wireless station based at least in part on the first timing information for rotating wireless frame anonymization parameters for the first EDP group; transmitting an EDP request frame to the wireless station, wherein the EDP request frame indicates (i) a request for the wireless station to join a second EDP group different from the first EDP group and (ii) one or more epoch parameters for the second EDP group; and maintaining the wireless communications link with the wireless station based at least in part on second timing information for rotating wireless frame anonymization parameters for the second EDP group.
Clause 2: The method of Clause 1, further comprising providing a communication indicating that the AP supports a randomized media access control (MAC) address rotation management protocol.
Clause 3: The method in accordance with any of Clauses 1-2, further comprising receiving a response from the wireless station indicating a status of a transition to the second EDP group.
Clause 4: The method in accordance with any of Clauses 1-3, further comprising selecting the second EDP group based in part on one or more minimum epoch pacing parameters received from the wireless station.
Clause 5: The method in accordance with any of Clauses 1-4, further comprising receiving, from the wireless station, rotation pace preference information, wherein the rotation pace preference information indicates a preferred rotation pace for rotating wireless frame anonymization parameters, wherein the first EDP group is assigned based at least in part on the rotation pace preference information.
Clause 6: The method of Clause 5, wherein the first EDP group is selected from a plurality of EDP groups based on a best match between the rotation pace preference information and timing information for rotating wireless frame anonymization parameters corresponding to the plurality of EDP groups.
Clause 7: The method in accordance with any of Clauses 1-6, wherein: establishing the wireless communications link comprises receiving an association request frame from the wireless station, the association request frame indicating support for EDP groups; and the wireless frame indicating the first EDP group is an association response frame.
Clause 8: The method of Clause 7, wherein the first EDP group is a default EDP group if the association request frame lacks an indication of preferred pacing parameters.
Clause 9: The method in accordance with any of Clauses 7-8, wherein the association request frame comprises an EDP element, the EDP element comprising a minimum epoch pacing parameter.
Clause 10: The method in accordance with any of Clauses 1-9, wherein the EDP request frame is multicast to a plurality of wireless stations in a basic service set.
Clause 11: An access point (AP) comprising: one or more memories collectively storing instructions; and one or more processors communicatively coupled to the one or more memories, the one or more processors being individually or collectively configured to execute the instructions to cause the AP to perform an operation comprising: establishing a wireless communications link between the AP and a wireless station, comprising assigning the wireless station to a first enhanced data privacy (EDP) group associated with first timing information for rotating wireless frame anonymization parameters at epoch transitions; transmitting a wireless frame to the wireless station indicating the first EDP group; maintaining the wireless communications link with the wireless station based at least in part on the first timing information for rotating wireless frame anonymization parameters for the first EDP group; transmitting an EDP request frame to the wireless station, wherein the EDP request frame indicates (i) a request for the wireless station to join a second EDP group different from the first EDP group and (ii) one or more epoch parameters for the second EDP group; and maintaining the wireless communications link with the wireless station based at least in part on second timing information for rotating wireless frame anonymization parameters for the second EDP group.
Clause 12: The AP of Clause 11, the operation further comprising providing a communication indicating that the AP supports a randomized MAC address rotation management protocol.
Clause 13: The AP in accordance with any of Clauses 11-12, the operation further comprising receiving a response from the wireless station indicating a status of a transition to the second EDP group.
Clause 14: The AP in accordance with any of Clauses 11-13, the operation further comprising selecting the second EDP group based in part on one or more minimum epoch pacing parameters received from the wireless station.
Clause 15: The AP in accordance with any of Clauses 11-14, the operation further comprising receiving, from the wireless station, rotation pace preference information, wherein the rotation pace preference information indicates a preferred rotation pace for rotating wireless frame anonymization parameters, wherein the first EDP group is assigned based at least in part on the rotation pace preference information.
Clause 16: The AP of Clause 15, wherein the first EDP group is selected from a plurality of EDP groups based on a best match between the rotation pace preference information and timing information for rotating wireless frame anonymization parameters corresponding to the plurality of EDP groups.
Clause 17: The AP in accordance with any of Clauses 11-16, wherein: establishing the wireless communications link comprises receiving an association request frame from the wireless station, the association request frame indicating support for EDP groups; and the wireless frame indicating the first EDP group is an association response frame.
Clause 18: The AP of Clause 17, wherein the first EDP group is a default EDP group if the association request frame lacks an indication of preferred pacing parameters.
Clause 19: The AP in accordance with any of Clauses 17-18, wherein the association request frame comprises an EDP element, the EDP element comprising a minimum epoch pacing parameter.
Clause 20: The AP in accordance with any of Clauses 11-19, wherein the EDP request frame is multicast to a plurality of wireless stations in a basic service set.
Clause 21: A non-transitory computer-readable medium comprising computer-executable code, which when executed by one or more processors of an access point (AP) perform an operation comprising: establishing a wireless communications link between the AP and a wireless station, comprising assigning the wireless station to a first enhanced data privacy (EDP) group associated with first timing information for rotating wireless frame anonymization parameters at epoch transitions; transmitting a wireless frame to the wireless station indicating the first EDP group; maintaining the wireless communications link with the wireless station based at least in part on the first timing information for rotating wireless frame anonymization parameters for the first EDP group; transmitting an EDP request frame to the wireless station, wherein the EDP request frame indicates (i) a request for the wireless station to join a second EDP group different from the first EDP group and (ii) one or more epoch parameters for the second EDP group; and maintaining the wireless communications link with the wireless station based at least in part on second timing information for rotating wireless frame anonymization parameters for the second EDP group.
Clause 22: A method comprising: establishing, by an access point (AP), a wireless communications link between the AP and a wireless station, wherein establishing the wireless communications link comprises assigning the wireless station to an Enhanced Data Privacy (EDP) group, the EDP group associated with timing information for rotating wireless frame anonymization parameters at epoch transitions; transmitting a wireless frame to the wireless station indicating the assigned EDP group; maintaining, by the AP, the wireless communications link with the wireless station based at least in part on the timing information for randomized MAC address rotation for the assigned EDP group; transmitting an EDP request frame to the wireless station, wherein the EDP request frame indicates a request for the wireless station to join a second EDP group different from the assigned EDP group, wherein the EDP request frame indicates one or more epoch parameters for the second EDP group; and maintaining, by the AP, the wireless communications link with the wireless station based at least in part on timing information for randomized MAC address rotation for the second EDP group.
Clause 23: A computing device comprising: one or more memories collectively storing instructions; and one or more processors communicatively coupled to the one or more memories, the one or more processors being individually or collectively configured to execute the instructions to cause the computing device to perform a method in accordance with any of Clauses 1-10 and 22.
Clause 24: A non-transitory computer-readable medium comprising computer-executable code, which when executed by one or more processors of a computing device perform a method in accordance with any of Clauses 1-10 and 22.
Clause 25: An apparatus comprising means for performing a method in accordance with any of Clauses 1-10 and 22.

As used herein, “a processor,” “at least one processor,” or “one or more processors” generally refers to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory,” or “one or more memories” generally refers to a single memory configured to store data and/or instructions or multiple memories configured to collectively store data and/or instructions.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A method for wireless communication performed by an access point (AP), comprising:
establishing a wireless communications link between the AP and a wireless station, comprising assigning the wireless station to a first enhanced data privacy (EDP) group associated with first timing information for rotating wireless frame anonymization parameters at epoch transitions;
transmitting a wireless frame to the wireless station indicating the first EDP group;
maintaining the wireless communications link with the wireless station based at least in part on the first timing information for rotating wireless frame anonymization parameters for the first EDP group;
transmitting an EDP request frame to the wireless station, wherein the EDP request frame indicates (i) a request for the wireless station to join a second EDP group different from the first EDP group and (ii) one or more epoch parameters for the second EDP group; and
maintaining the wireless communications link with the wireless station based at least in part on second timing information for rotating wireless frame anonymization parameters for the second EDP group.

2. The method of claim 1, further comprising providing a communication indicating that the AP supports a randomized media access control (MAC) address rotation management protocol.

3. The method of claim 1, further comprising receiving a response from the wireless station indicating a status of a transition to the second EDP group.

4. The method of claim 1, further comprising selecting the second EDP group based in part on one or more minimum epoch pacing parameters received from the wireless station.

5. The method of claim 1, further comprising receiving, from the wireless station, rotation pace preference information, wherein the rotation pace preference information indicates a preferred rotation pace for rotating wireless frame anonymization parameters, wherein the first EDP group is assigned based at least in part on the rotation pace preference information.

6. The method of claim 5, wherein the first EDP group is selected from a plurality of EDP groups based on a best match between the rotation pace preference information and timing information for rotating wireless frame anonymization parameters corresponding to the plurality of EDP groups.

7. The method of claim 1, wherein:
establishing the wireless communications link comprises receiving an association request frame from the wireless station, the association request frame indicating support for EDP groups; and
the wireless frame indicating the first EDP group is an association response frame.

8. The method of claim 7, wherein the first EDP group is a default EDP group if the association request frame lacks an indication of preferred pacing parameters.

9. The method of claim 7, wherein the association request frame comprises an EDP element, the EDP element comprising a minimum epoch pacing parameter.

10. The method of claim 1, wherein the EDP request frame is multicast to a plurality of wireless stations in a basic service set.

11. An access point (AP) comprising:
one or more memories collectively storing instructions; and
one or more processors communicatively coupled to the one or more memories, the one or more processors being individually or collectively configured to execute the instructions to cause the AP to perform an operation comprising:
establishing a wireless communications link between the AP and a wireless station, comprising assigning the wireless station to a first enhanced data privacy (EDP) group associated with first timing information for rotating wireless frame anonymization parameters at epoch transitions;
transmitting a wireless frame to the wireless station indicating the first EDP group;
maintaining the wireless communications link with the wireless station based at least in part on the first timing information for rotating wireless frame anonymization parameters for the first EDP group;
transmitting an EDP request frame to the wireless station, wherein the EDP request frame indicates (i) a request for the wireless station to join a second EDP group different from the first EDP group and (ii) one or more epoch parameters for the second EDP group; and
maintaining the wireless communications link with the wireless station based at least in part on second timing information for rotating wireless frame anonymization parameters for the second EDP group.

12. The AP of claim 11, the operation further comprising providing a communication indicating that the AP supports a randomized MAC address rotation management protocol.

13. The AP of claim 11, the operation further comprising receiving a response from the wireless station indicating a status of a transition to the second EDP group.

14. The AP of claim 11, the operation further comprising selecting the second EDP group based in part on one or more minimum epoch pacing parameters received from the wireless station.

15. The AP of claim 11, the operation further comprising receiving, from the wireless station, rotation pace preference information, wherein the rotation pace preference information indicates a preferred rotation pace for rotating wireless frame anonymization parameters, wherein the first EDP group is assigned based at least in part on the rotation pace preference information.

16. The AP of claim 15, wherein the first EDP group is selected from a plurality of EDP groups based on a best match between the rotation pace preference information and timing information for rotating wireless frame anonymization parameters corresponding to the plurality of EDP groups.

17. The AP of claim 11, wherein:
establishing the wireless communications link comprises receiving an association request frame from the wireless station, the association request frame indicating support for EDP groups; and
the wireless frame indicating the first EDP group is an association response frame.

18. The AP of claim 17, wherein the first EDP group is a default EDP group if the association request frame lacks an indication of preferred pacing parameters.

19. The AP of claim 17, wherein the association request frame comprises an EDP element, the EDP element comprising a minimum epoch pacing parameter.

20. A non-transitory computer-readable medium comprising computer-executable code, which when executed by one or more processors of an access point (AP) perform an operation comprising:
establishing a wireless communications link between the AP and a wireless station, comprising assigning the wireless station to a first enhanced data privacy (EDP) group associated with first timing information for rotating wireless frame anonymization parameters at epoch transitions;
transmitting a wireless frame to the wireless station indicating the first EDP group;
maintaining the wireless communications link with the wireless station based at least in part on the first timing information for rotating wireless frame anonymization parameters for the first EDP group;
transmitting an EDP request frame to the wireless station, wherein the EDP request frame indicates (i) a request for the wireless station to join a second EDP group different from the first EDP group and (ii) one or more epoch parameters for the second EDP group; and
maintaining the wireless communications link with the wireless station based at least in part on second timing information for rotating wireless frame anonymization parameters for the second EDP group.
